(19) United States
(12) Patent Application Publication
(10) Pub. No.: US 2026/0138612 A1
(43) Pub. Date: May 21, 2026

(54) SYSTEM AND METHOD OF TRAJECTORY CONSTRUCTION FOR TRANSITIONS BETWEEN LANE CENTERING APPLICATIONS

(71) Applicant: GM Global Technology Operations LLC, Detroit, MI (US)

(72) Inventors: Xuefei Yang, Northville, MI (US); Paul A. Adam, Milford, MI (US); Tetyana V. Mamchuk, Novi, MI (US); Harsh Ketan Patel, New Hudson, MI (US); Xueying Kang, Novi, MI (US)

(73) Assignee: GM Global Technology Operations LLC, Detroit, MI (US)

(21) Appl. No.: 18/953,443

(22) Filed: Nov. 20, 2024

(51) Int. Cl. B60W 30/182; B60W 30/02

(52) U.S. Cl. CPC B60W 30/182; B60W 30/02; B60W 2552/20

(57) ABSTRACT

A system and method include, while engaged in a first feature mode of a vehicle, receiving a request to engage a second feature mode of the vehicle, the second feature mode different from the first feature mode, and identifying, based on conditions of the vehicle, that a trajectory of the vehicle is offset from a center of a lane of the vehicle. The system and method also include determining that the conditions of the vehicle do not exceed a dynamic stabilization threshold and generating trajectory instructions instructing the vehicle to transition from the first feature mode of the vehicle to the second feature mode of the vehicle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to trajectory constructions for transitions between lane centering applications. Autonomous lane centering applications are integral components of modern autonomous vehicle systems, designed to maintain a vehicle's position within a designated lane. These applications utilize a combination of sensors, cameras, and advanced algorithms to detect lane markings and adjust the vehicle's steering to keep it centered. By continuously monitoring the vehicle's position relative to the lane boundaries, these systems can make real-time adjustments to ensure the vehicle remains within the lane, thereby enhancing safety and reducing driver fatigue. Current lane centering technologies are capable of handling various driving conditions, including straight roads, curves, and lane changes, by maintaining a consistent position within the lane.

However, when transitioning from one lane centering application to another, existing autonomous vehicle systems typically require the vehicle to return to the center of the lane. This requirement can lead to abrupt or inefficient trajectory changes when the vehicle is intentionally positioned off-center within the lane, such as during lane merges or to avoid obstacles. The necessity to re-center the vehicle before switching applications can result in a less smooth driving experience and may prompt the driver to provide input or intervene. Addressing this limitation is crucial for developing more advanced and seamless autonomous driving technologies.

### SUMMARY

One aspect of the disclosure provides a computer-implemented method for trajectory construction for transitions between lane centering applications that when executed on data processing hardware causes the data processing hardware to perform operations that include, while engaged in a first feature mode of a vehicle, receiving a request to engage a second feature mode of the vehicle, the second feature mode different from the first feature mode, and identifying, based on conditions of the vehicle, that a trajectory of the vehicle is offset from a center of a lane of the vehicle. The system and method also include determining that the conditions of the vehicle do not exceed a dynamic stabilization threshold, and generating trajectory instructions instructing the vehicle to transition from the first feature mode of the vehicle to the second feature mode of the vehicle.

Implementations of the disclosure may include one or more of the following optional features. In some implementations, the trajectory instructions maintain the trajectory of the vehicle that is offset from the center of the lane of the vehicle as the vehicle transitions from the first feature mode to the second feature mode. In some examples, the first feature mode includes a first set of feature states and the second feature mode includes a second set of feature states. In these examples, the first set of feature states and the second set of feature states may include at least one common feature state. Here, the trajectory instructions may blend the at least one common feature state as the vehicle transitions from the first feature mode to the second feature mode. Additionally or alternatively, the operations may further include applying a gradient rate limiter to the at least one common feature state as the vehicle transitions from the first feature mode to the second feature mode.

In some implementations, the conditions of the vehicle include one or more of a heading angle of the vehicle with respect to the center of the lane of the vehicle, and a lateral offset of the vehicle with respect to the center of the lane of the vehicle. In some examples, the operations further include receiving initial road conditions of the lane of the vehicle and setting the dynamic stabilization threshold based on the road conditions of the lane of the vehicle. Here, the road conditions may include one or more of a width of the lane of the vehicle, a curvature of the lane of the vehicle, road features, and accessories of the vehicle. Additionally or alternatively, the operations further include receiving updated road conditions of the lane of the vehicle, the updated road conditions different from the initial road conditions, and adjusting the dynamic stabilization threshold based on the updated road conditions of the lane of the vehicle.

Another aspect of the disclosure provides a system for trajectory construction for transitions between lane centering applications that includes data processing hardware and memory hardware in communication with the data processing hardware. The memory hardware stores instructions that when executed by the data processing hardware cause the data processing hardware to perform operations that include, while engaged in a first feature mode of a vehicle, receiving a request to engage a second feature mode of the vehicle, the second feature mode different from the first feature mode, and identifying, based on conditions of the vehicle, that a trajectory of the vehicle is offset from a center of a lane of the vehicle. The system and method also include determining that the conditions of the vehicle do not exceed a dynamic stabilization threshold and generating trajectory instructions instructing the vehicle to transition from the first feature mode of the vehicle to the second feature mode of the vehicle.

This aspect may include one or more of the following optional features. In some implementations, the trajectory instructions maintain the trajectory of the vehicle that is offset from the center of the lane of the vehicle as the vehicle transitions from the first feature mode to the second feature mode. In some examples, the first feature mode includes a first set of feature states and the second feature mode includes a second set of feature states. In these examples, the first set of feature states and the second set of feature states may include at least one common feature state. Here, the trajectory instructions may blend the at least one common feature state as the vehicle transitions from the first feature mode to the second feature mode. Additionally or alternatively, the operations may further include applying a gradient rate limiter to the at least one common feature state as the vehicle transitions from the first feature mode to the second feature mode. In some implementations, the conditions of the vehicle include one or more of a heading angle of the vehicle with respect to the center of the lane of the vehicle, and a lateral offset of the vehicle with respect to the center of the lane of the vehicle.

Another aspect of the disclosure provides a method for dynamically adjusting a stabilization threshold of centering applications that when executed on data processing hardware causes the data processing hardware to perform operations that include receiving initial road conditions of a lane of a vehicle, setting a dynamic stabilization threshold based on the initial road conditions of the lane of the vehicle, and identifying conditions of the vehicle. The operations also include performing a stabilization check of the vehicle to determine whether the conditions of the vehicle exceed the dynamic stabilization threshold. When the conditions of the vehicle do not exceed the dynamic stabilization threshold, the operations further include permitting the vehicle to transition between a first feature mode and a second feature mode.

This aspect may include one or more of the following optional features. In some implementations, the road conditions include one or more of a width of the lane of the vehicle, a curvature of the lane of the vehicle, road features, and accessories of the vehicle. Additionally or alternatively, the operations further include receiving updated road conditions of the lane of the vehicle, the updated road conditions different from the initial road conditions, and adjusting the dynamic stabilization threshold based on the updated road conditions of the lane of the vehicle.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for trajectory construction for transitions between lane centering applications.

FIG. 2 is a schematic view of example components of the system of FIG. 1.

FIG. 3 is an offset arbitration model for the system of FIG. 1.

FIGS. 4A-4D are schematic views of a dynamic stabilization threshold of the system of FIG. 1 as an environment of a vehicle changes.

FIG. 5 is a flowchart of an example arrangement of operations for a method of trajectory construction for transitions between lane centering applications.

FIG. 6 is a flowchart of an example arrangement of operations for a method of dynamically adjusting a stabilization threshold of centering applications.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

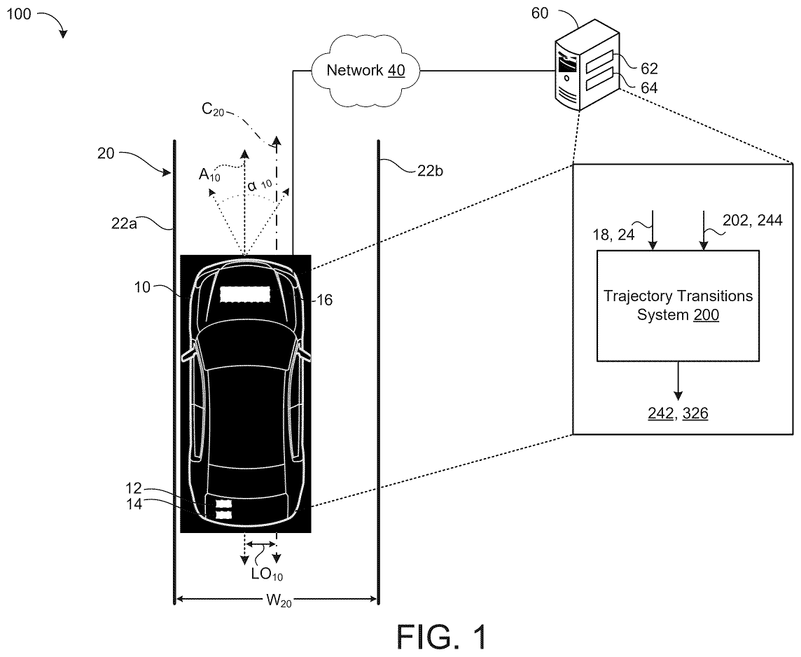

FIG. 1 illustrates an example system 100 including a vehicle 10 and/or a remote system 60 in communication with the vehicle 10 via a network 40. The vehicle 10 and/or the remote system 60 executes a trajectory transition system 200 that operates when a user engages a system control feature mode 242 (e.g., a hands-free or hands-on control) of the vehicle 10. In the examples shown, the trajectory transition system 200 is implemented within a vehicle 10. However, the trajectory transition system 200 can be implemented on other computing devices (e.g., computing devices in communication with the vehicle 10), such as, without limitation, a smart phone, tablet, smart display, desktop/laptop, smart watch, smart appliance, or smart glasses/headset. Additionally or alternatively, the trajectory transition system 200 may be implemented in any other propulsion system, such as, without limitation, motorcycles, trucks, off-road vehicles, farm equipment, trains, aircraft, and the like. The vehicle 10 includes data processing hardware 12 and memory hardware 14 storing instructions that when executed on the data processing hardware 12 cause the data processing hardware 14 to perform operations. The vehicle 10 further includes one or more sensors 16 configured to capture/receive sensor data indicating conditions 18 of the vehicle 10. The one or more sensors 16 may include one or more long range radar sensors and/or one or more camera sensors capable of capturing image data. The conditions 18 may generally include the yaw, velocity, acceleration, angle of approach, and other conditions of the vehicle 10 that may impact the trajectory of the vehicle 10.

As shown in FIG. 1, the vehicle 10 includes a central, longitudinal axis A₁₀ and is driving within a lane 20 having a center C₂₀. The lane 20 may be further defined by lane markers 22a, 22b that are spaced apart from one another by a width W₂₀ of the lane 20. A position of the vehicle 10 with respect to the center C₂₀ of the lane 20 may be defined by a lateral offset LO₁₀ of the central longitudinal axis A₁₀ from the center C₂₀ of the lane 20. Similarly, a heading of the vehicle 10 may be defined by a heading angle α₁₀ of the longitudinal axis A₁₀ of the vehicle 10 with respect to the center C₂₀ of the lane 20. The conditions 18 of the vehicle 10 may include the lateral offset LO₁₀ and the heading angle α₁₀ which cooperate to define the trajectory of the vehicle 10 within the lane 20. In instances where the longitudinal axis A₁₀ is aligned with the center C₂₀ of the lane 20 and the heading angle α₁₀ is zero (0) with respect to the center C₂₀ of the lane 20, the vehicle 10 may be considered to be driving with an on-center trajectory. Conversely, where the longitudinal axis A₁₀ is spaced apart from the center C₂₀ of the lane 20 by a lateral offset L₁₀, and/or the heading angle α₁₀ is a number greater than zero (0) with respect to the center C₂₀ of the lane 20, the vehicle 10 may be considered to be driving with an offset trajectory.

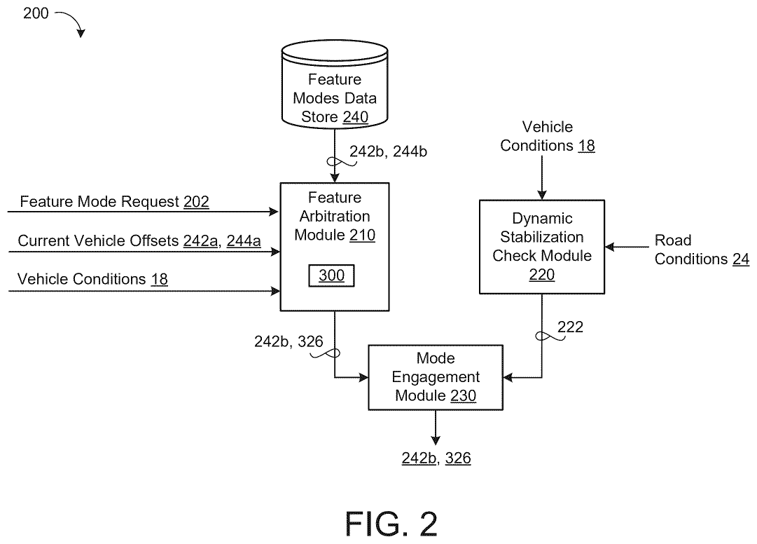

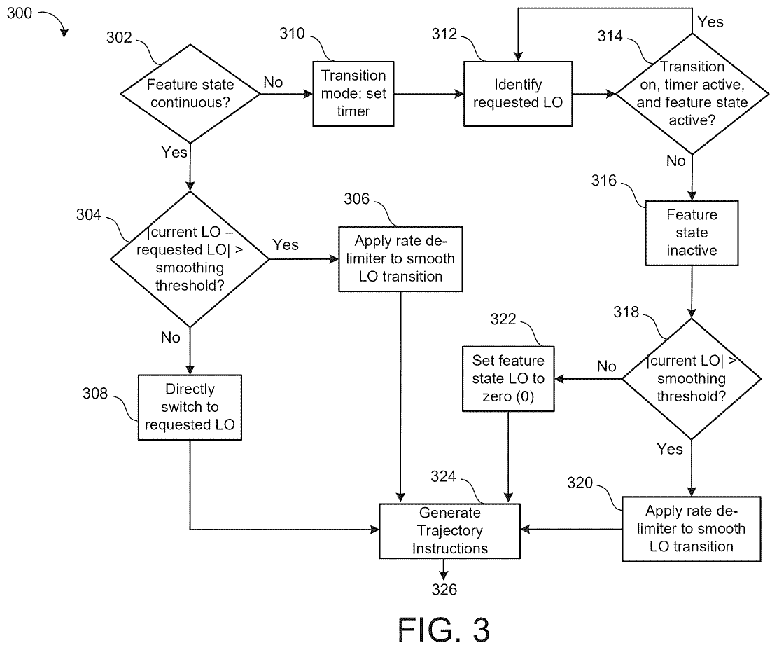

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the trajectory transition system 200 is shared across the vehicle 10 and the remote system 60. As described in greater detail below with reference to FIGS. 2 and 3, the trajectory transition system 200 executing on the vehicle 10 and/or the remote system 60 executes a feature arbitration module 210, a dynamic stabilization check module 220, and a mode engagement module 230, and is configured to receive a request to change a feature mode 242 of the vehicle 10 from a first feature mode 242a to a second feature mode 242b and, when the conditions 18 of the vehicle 10 do not exceed a dynamic stabilization threshold, generate trajectory instructions 326 for the vehicle to transition from the first feature mode 242a to the second feature mode 242b while minimizing disruption to the driver of the vehicle 10 and eliminating the need for driver input or intervention. Notably, traditional methods of handoffs between lane centering feature modes 242 require that the longitudinal axis A₁₀ and the heading α₁₀ of the vehicle 10 be aligned with the center C₂₀ of the lane 20 before initiating the handoff. However, the trajectory transition system 200 performs this handoff between feature modes 242a, 242b while maintaining the current trajectory of the vehicle, regardless of whether the vehicle 10 is moving along an offset trajectory (i.e., lateral offset LO₁₀ and/or heading angle α₁₀) with respect to the center C₂₀ of the lane 20.

As used herein, each feature mode 242 may generally refer to a type of lateral offset LO₁₀ of the vehicle 10 from the center C₂₀ of the lane 20 in which the vehicle 10 is traveling. The feature modes 242 may include hands-on lane centering, as well as hands-off lane centering. For example, the feature modes 242 may include SuperCruise® Hands-Free Driving, Hands on Lane Centering, and other applications where the vehicle 10 is intentionally not centered within the lane 20. As described in further detail below, each feature mode 242 may include a corresponding set of feature states 244 that are incorporated/arbitrated to maintain the trajectory of the vehicle 10 with respect to the center C₂₀ of the lane 20. For instance, the feature states 244 may include, without limitation, a vehicle encroachment lateral offset, a driver requested lateral offset, a non-divided road lateral offset, a straddle lateral offset, a maintain prof lateral offset, a curvature lateral offset, a construction zone lateral offset, a lane change target lane lateral offset, a path lane keep assist lateral offset, and a behavior planner lateral offset. In some instances, each feature mode 242 has a unique set of feature states 244 that includes and/or omits a feature state 244 of another feature mode 242. For example, the path lane keep assist lateral offset feature state 244 may be relevant for a first feature mode 242a, but not for a second feature mode 242b. In other examples, one or more feature modes 242 may share feature states 244 such that, when the vehicle 10 transitions between features states 242 (e.g., from a first feature mode 242a to a second feature mode 242b) one or more feature states 244 that are active in the first feature mode 242a remain active in the second feature mode 242b.

With reference to FIGS. 1 and 2, while the vehicle 10 is moving and engaged in a first feature mode 242a, the feature arbitration module 210 of the trajectory transitions system 200 is configured to receive, as input, a feature request 202 to engage a second feature mode 242b of the vehicle 10 that is different from the first feature mode 244a. The feature request 202 may be received from a driver and/or passenger of the vehicle 10 or may be automatically initiated by another control process of the vehicle 10. As shown, the feature arbitration module 210 has access to a feature modes data store 240, which may be stored on any one of the memory hardware 14, 64. The feature modes data store 240 stores the feature modes 242 of the vehicle 10, and for each feature mode 242, its corresponding set of feature states 244. For instance, the first feature mode 242a includes the first set of feature states 244a, while the second feature mode 242b includes the second set of feature states 244b. Here, the first set of feature states 244a and the second set of feature states 244b may have at least one common feature state 244. In other instances, the first set of feature states 244a and the second set of feature states 244b may not share any common feature states 244.

The feature arbitration module 210 may additionally receive, as input, the first set of feature states 244a corresponding to the first feature mode 242a, and the conditions 18 of the vehicle 10. Based on the conditions 18 of the vehicle 10, the feature arbitration mode 210 may identify that the trajectory of the vehicle 10 is offset from the center C₂₀ of the lane 20 of the vehicle 10. The feature arbitration module 210 may further receive the requested second feature mode 242b and corresponding second set of feature states 242b as input, and generate, as output, trajectory instructions 326 instructing the vehicle 10 to transition from the first feature mode 242a of the vehicle 10 to the second feature mode 242b of the vehicle 10. Here, though the trajectory of the vehicle 10 is offset from the center C₂₀ of the lane 20 of the vehicle 10, the trajectory instructions 326 maintain the offset trajectory of the vehicle 10 as it transitions from the first feature mode 242a to the second feature mode 242b.

With reference to FIGS. 2 and 3, the feature arbitration module 210 executes an offset arbitration model 300 that, for each feature state 244 of the first set of features states 244a, determines how to transition the feature state 244 from the first feature mode 242a to the second feature mode 242b, and generates the trajectory instructions 326 for the vehicle 10 to maintain its current trajectory as it transitions engagement from the first feature mode 242a to the second feature mode 242b. In other words, the feature arbitration module 210 may perform arbitration for each feature state 244 currently engaged by the first feature mode 242a to determine how to either taper off or zero off the feature state 244, or how to smoothly transition the feature state 244 to its use in the second feature mode 242b. By performing arbitration, the offset arbitration model 300 enables a smooth transition between the first feature mode 242a and the second feature mode 242b by seamlessly integrating and accommodating varying lateral offset values of each of the feature states 244a, 244b.

At operation 302, the offset arbitration model 300 determines whether the particular feature state 244 is continuous between the first feature mode 242a and the second feature mode 242b. Here, the offset arbitration model 300 may determine that the particular feature state 244 is continuous when it is present in the first set of feature states 244a and the second set of feature states 244b. If the feature state 244 is continuous between the first feature mode 242a and the second feature mode 242b, the offset arbitration model 300 proceeds to operation 304, which determines whether the absolute value of the difference between the current lateral offset LO₁₀ of the vehicle 10 and the requested lateral offset LO₁₀ of the vehicle 10 (i.e., specified in the request 202) is greater than a smoothing threshold. Here, the smoothing threshold may be a configurable threshold that minimizes jerk of the vehicle between feature modes 242a, 242b.

If the absolute value of the difference between the current lateral offset LO₁₀ of the vehicle 10 and the requested lateral offset LO₁₀ of the vehicle 10 is greater than the smoothing threshold, the offset arbitration model 300 proceeds to operation 306, and applies a gradient rate limiter to the continuous particular feature state 244 that is common between the first feature mode 242a and the second feature mode 242b to smooth the transition between the current lateral offset LO₁₀ of the vehicle 10 and the requested lateral offset LO₁₀ of the vehicle 10. Thereafter, at operation 324, the offset arbitration model 300 may blend the aggregate of all of the feature states 244 to generate the final trajectory instructions 326. In some instances, the offset arbitration model 300 blends the feature states 244 by calculating a trajectory for each feature state 244 in a cubic polynomial form and solving the system using Gaussian elimination on a sequence of augmented matrices until the final matrix is in an upper triangular form, which is used to create a blended trajectory used to generate the trajectory instructions 326. In other cases, the offset arbitration model 300 blends the feature states 244 by comparing the direction of the lateral offset LO₁₀ associated with each feature state 244 where a left direction offset has a positive sign and a right direction offset has a negative sign. In these cases, where all offsets are positive, the maximum value of the offsets is used to generate the trajectory instructions 326. Where all offsets are negative, the minimum value of the offsets is used to generate the trajectory instructions 326, and in all other scenarios a weighted sum is taken to generate the trajectory instructions 326.

If the absolute value of the difference between the current lateral offset LO₁₀ of the vehicle 10 and the requested lateral offset LO₁₀ of the vehicle 10 is less than the smoothing threshold, the offset arbitration model 300 proceeds to operation 308, and determines to directly switch the current lateral offset LO₁₀ of the feature state 244 to the requested lateral offset LO₁₀ specified by the request 202 without applying a rate limiter to the lateral offset LO₁₀ of the feature state 244. Here, the switch without applying the rate limiter may be included in the trajectory instructions 326 when the feature states 244 are blended at operation 324.

Conversely, if the offset arbitration model 300 determines that the particular feature state 244 is not continuous between the first feature mode 242a and the second feature mode 242b, the offset arbitration model 300 proceeds to operation 310, and sets a transition mode timer. Thereafter, at operation 312, the offset arbitration model 300 may identify the requested lateral offset LO₁₀ associated with the particular feature state 244 and, at operation 314, determine whether the requested lateral offset LO₁₀ associated with the particular feature state 244 is any of already in transition, has an active transition mode timer, or is a currently active feature state 244. If the requested lateral offset LO₁₀ associated with the particular feature state 244 is any of already in transition, has an active transition mode timer, or is a currently active feature state 244, the offset arbitration model 300 continues to monitor the requested lateral offset LO₁₀ associated with the particular feature state 244. If, however, the requested lateral offset LO₁₀ associated with the particular feature state 244 is any of not in transition, has an expired transition mode timer, or is an inactive feature state 244, the offset arbitration model 300 proceeds to operation 316, and identifies that the feature state 244 is inactive.

At operation 318, the offset arbitration model 300 determines whether the absolute value of the current lateral offset LO₁₀ of the feature state 244 is greater than the smoothing threshold, and when it is, proceeds to operation 320 and applies a rate limiter to the current lateral offset LO₁₀ to smooth the transition of the feature state 244 from the first feature mode 242a to the second feature mode 242b. Here, the applied rate limiter may be included in the trajectory instructions 326 when the feature states 244 are blended. Conversely, at operation 322, if the absolute value of the current lateral offset LO₁₀ of the feature state 244 is less than the smoothing threshold, the offset arbitration model 300 sets the feature state 244 of the current lateral offset LO₁₀ to zero (0). At operation 324, the offset arbitration model 300 may blend the feature states 244 including the current lateral offset LO₁₀ that is set to zero (0) when generating the trajectory instructions 326.

Referring again to FIG. 2, while the feature arbitration module 210 executes the offset arbitration model 300 to generate the trajectory instructions 326, the dynamic stabilization check module 220 determines whether the transition from the first feature mode 242a to the second feature mode 242b exceeds a dynamic stabilization threshold. In other words, the dynamic stabilization check module 220 detects whether the current trajectory of the vehicle 10 is stable enough to engage in a hand-off between the first feature mode 242a to the second feature mode 242b. Advantageously, the dynamic stabilization check module 220 may dynamically adjust and/or update the dynamic stabilization threshold that the current trajectory must meet to initiate the transition between feature modes 242a, 242b as the lane and environment surrounding the vehicle 10 change.

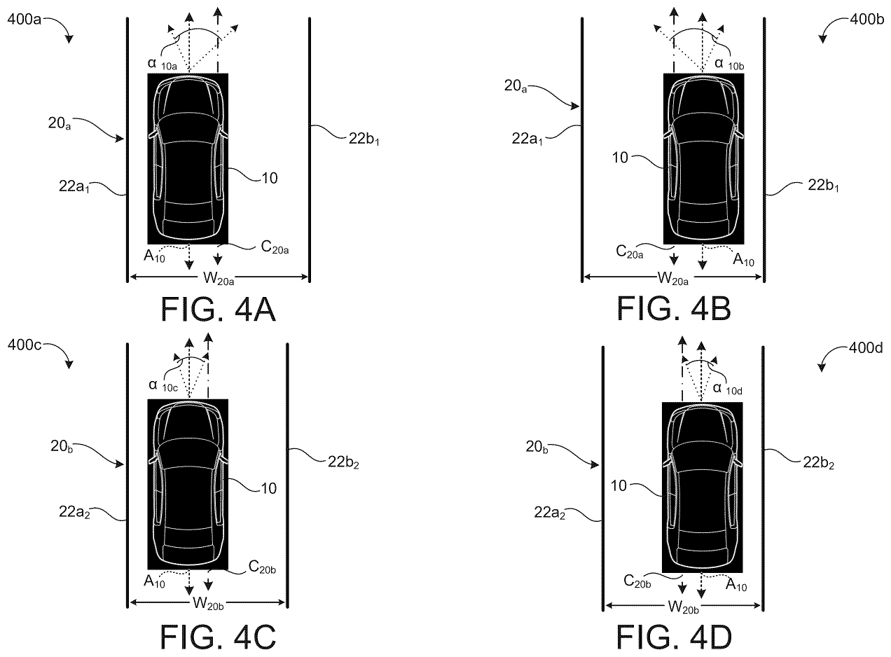

With particular reference to FIGS. 4A-4D, environments 400a-400d are shown and each includes the vehicle 10 driving in a lane 20a, 20b, where the dynamic stabilization check module 220 dynamically updates the dynamic stabilization threshold. Notably, the lane 20a shown in FIGS. 4A and 4B has a wider width W₂₀ₐ than a width W_{20b} of the lane 20b shown in FIGS. 4C and 4D. Referring to FIG. 4A, the vehicle 10 may be driving with an offset trajectory to the left of the center C₂₀ₐ of the lane 20a such that the longitudinal axis A₁₀ of the vehicle 10 is offset to the left (i.e., closer to the left lane marker 22a₁) of the Center C₂₀ₐ of the lane 20a. Here, based on the road conditions 24 indicating the wider lane 20a and the trajectory of the vehicle 10 within the lane 20a, the dynamic stabilization check module 220 adjusts the heading angle α₁₀ₐ of the dynamic stabilization threshold to increase the threshold for trajectories to the right, while decreasing the threshold for trajectories to the left.

Referring to FIG. 4A, the vehicle 10 is still driving in the lane 20a having the width W₂₀ₐ. Here, the vehicle 10 has moved to an offset trajectory to the right of the center C₂₀ₐ of the lane 20a such that the longitudinal axis A₁₀ of the vehicle 10 is now offset to the right (i.e., closer to the right lane marker 22b₁) of the Center C₂₀ₐ of the lane 20a. Here, based on the road conditions 24 indicating the wider lane 20a and the trajectory of the vehicle 10 within the lane 20a, the dynamic stabilization check module 220 adjusts the heading angle α_{10b} of the dynamic stabilization threshold to increase the threshold for trajectories to the left, while decreasing the threshold for trajectories to the right.

Referring to FIG. 4C, the vehicle 10 is now driving in the lane 20b having a narrower width W_{20b} than the width W₂₀ₐ of the lane 20a. Here, the vehicle 10 is driving with the offset trajectory to the left of the center C_{20b} of the lane 20b such that the longitudinal axis A₁₀ of the vehicle 10 is offset to the left (i.e., closer to the left lane marker 22a₂) of the Center C_{20b} of the lane 20b. In response, the dynamic stabilization module 220 adjusts the heading angle α_{10c} of the dynamic stabilization threshold to decrease the threshold for trajectories to both the left and the right, where the trajectory threshold to the left is less than the trajectory threshold to the right. Similarly, referring to FIG. 4D, the vehicle 10 is still driving in the lane 20b, but is now offset to the right (i.e., closer to the right lane marker 22b₂) of the Center C_{20b} of the lane 20b. In response, the dynamic stabilization module 220 adjusts the heading angle α_{10d} of the dynamic stabilization threshold to shift the threshold for trajectories to both the left and the right, where the trajectory threshold to the right is now less than the trajectory threshold to the left.

Referring again to FIG. 2, the dynamic stabilization check module 220 may receive, as input, the vehicle conditions 18 indicating the trajectory of the vehicle 10, and initial road conditions 24 of the lane 20 in which the vehicle 10 is traveling. The road conditions 24 may generally include the width W₂₀ of the lane 20 of the vehicle 10, the curvature of the lane 20 of the vehicle 10, road features of the lane 20, and accessories (e.g., trailering mode) of the vehicle 10. Based on the received initial road conditions 24, the dynamic stabilization check module 220 may set a dynamic stabilization threshold. Thereafter, the dynamic stabilization check module 220 may perform a stabilization check to determine whether the conditions 18 of the vehicle 10 exceed the dynamic stabilization threshold. When the conditions 18 of the vehicle 10 do not exceed the dynamic stabilization threshold set by the initial road conditions 24, the dynamic stabilization check module 220 may generate a trigger to the mode engagement module 230 approving the mode engagement module 230 to permit the transition between the first feature mode 242a and the second feature mode 242b. Here, the mode engagement module 230 may additionally receive the trajectory instructions 236 from the feature arbitration module 210, and may generate, as output, the trajectory instructions 236 for transitioning to the second feature mode 242b.

In some instances, the dynamic stabilization check module 220 may receive, at a later time, updated road conditions 24 of the lane 20 of the vehicle 10. In these instances, the updated road conditions 24 are different from the initial road conditions 24 previous received by virtue of the mobility of the vehicle 10. Here, the dynamic stabilization check module 220 dynamically adjusts, in real time, the dynamic stabilization threshold based on the updated road conditions 24 of the lane 20 of the vehicle 10.

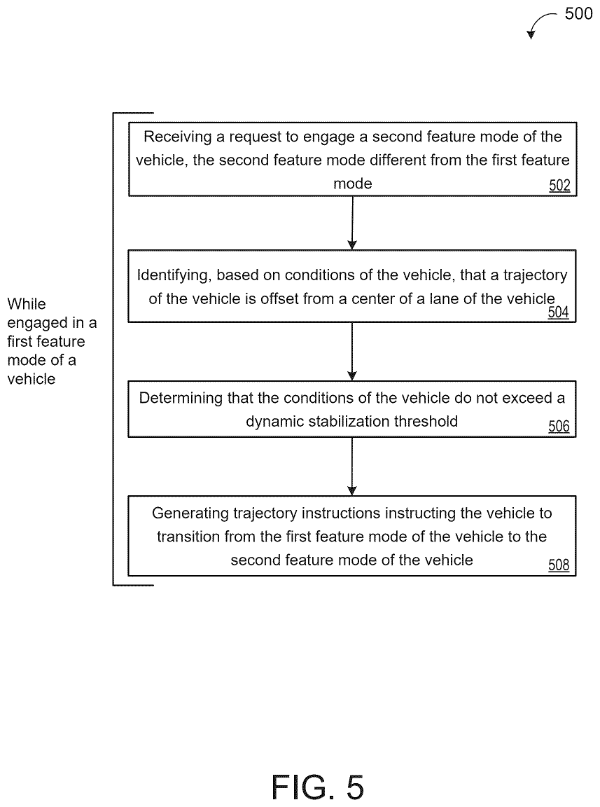

FIG. 5 includes a flowchart of an example arrangement of operations for a method 500 for dynamically adjusting a stabilization threshold of centering applications. The method 500 may be described with reference to FIGS. 1-4D. Data processing hardware (e.g., data processing hardware 12, 62 of FIG. 1) may execute instructions stored on memory hardware (e.g., memory hardware 14, 64 of FIG. 1) to perform the example arrangement of operations for the method 500.

The operations 502-508 of the method 500 may be performed while engaged in a first feature mode 242a of a vehicle 10. At operation 502, the method 500 includes receiving a request 202 to engage a second feature mode 242b of the vehicle 10. Here, the second feature mode 242b is different from the first feature mode 242a. At operation 504, the method 500 includes identifying, based on conditions 18 of the vehicle 10, that a trajectory of the vehicle is offset from a center C₂₀ of a lane 20 of the vehicle 10. The method 500 further includes, at operation 506, determining that the conditions 18 of the vehicle 10 do not exceed a dynamic stabilization threshold. At operation 508, the method 500 also includes generating trajectory instructions 326 instructing the vehicle 10 to transition from the first feature mode 242a of the vehicle 10 to the second feature mode 242b of the vehicle 10.

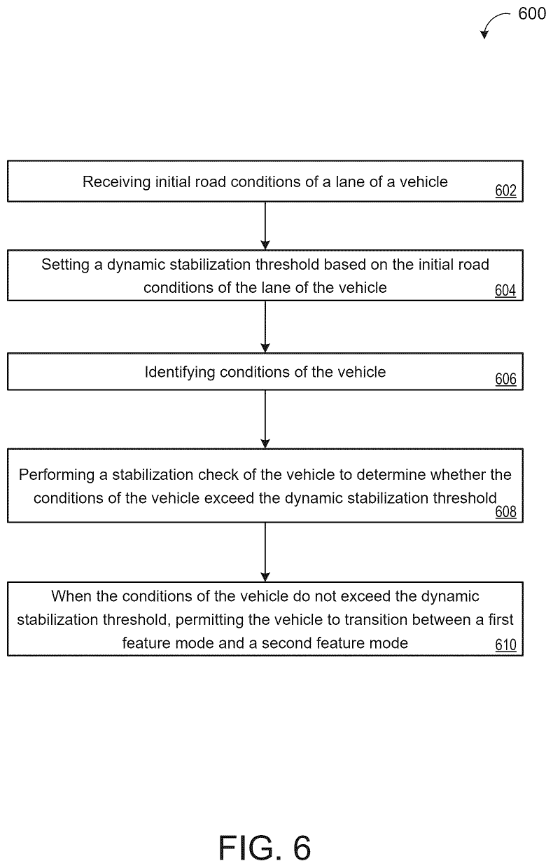

FIG. 6 includes a flowchart of an example arrangement of operations for a method 600 for dynamically adjusting a stabilization threshold of centering applications. The method 600 may be described with reference to FIGS. 1-4D. Data processing hardware (e.g., data processing hardware 12, 62 of FIG. 1) may execute instructions stored on memory hardware (e.g., memory hardware 14, 64 of FIG. 1) to perform the example arrangement of operations for the method 600.

At operation 602, the method 600 includes receiving initial road conditions 24 of a lane 20 of a vehicle 10. At operation 604, the method 600 also includes setting a dynamic stabilization threshold based on the initial road conditions 24 of the lane 20 of the vehicle 10. The method 600 also includes, at operation 606, identifying conditions 18 of the vehicle 10.

At operation 608, the method 600 further includes performing a stabilization check of the vehicle 10 to determine whether the conditions 18 of the vehicle 10 exceed the dynamic stabilization threshold. When the conditions 18 of the vehicle 10 do not exceed the dynamic stabilization threshold, the method 600 also includes, at operation 610, permitting the vehicle 10 to transition between a first feature mode 242a and a second feature mode 242b.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
while engaged in a first feature mode of a vehicle:
receiving a request to engage a second feature mode of the vehicle, the second feature mode different from the first feature mode;
identifying, based on conditions of the vehicle, that a trajectory of the vehicle is offset from a center of a lane of the vehicle;
determining that the conditions of the vehicle do not exceed a dynamic stabilization threshold; and
generating trajectory instructions instructing the vehicle to transition from the first feature mode of the vehicle to the second feature mode of the vehicle.

2. The method of claim 1, wherein the trajectory instructions maintain the trajectory of the vehicle that is offset from the center of the lane of the vehicle as the vehicle transitions from the first feature mode to the second feature mode.

3. The method of claim 1, wherein the first feature mode includes a first set of feature states and the second feature mode includes a second set of feature states.

4. The method of claim 3, wherein the first set of feature states and the second set of feature states includes at least one common feature state.

5. The method of claim 4, wherein the trajectory instructions blend the at least one common feature state as the vehicle transitions from the first feature mode to the second feature mode.

6. The method of claim 4, wherein the operations further include applying a gradient rate limiter to the at least one common feature state as the vehicle transitions from the first feature mode to the second feature mode.

7. The method of claim 1, wherein the conditions of the vehicle comprise one or more of:
a heading angle of the vehicle with respect to the center of the lane of the vehicle; and
a lateral offset of the vehicle with respect to the center of the lane of the vehicle.

8. The method of claim 1, wherein the operations further comprise:
receiving initial road conditions of the lane of the vehicle; and
setting the dynamic stabilization threshold based on the road conditions of the lane of the vehicle.

9. The method of claim 8, wherein the road conditions comprise one or more of:
a width of the lane of the vehicle;
a curvature of the lane of the vehicle;
road features; and
accessories of the vehicle.

10. The method of claim 8, wherein the operations further comprise:
receiving updated road conditions of the lane of the vehicle, the updated road conditions different from the initial road conditions; and
adjusting the dynamic stabilization threshold based on the updated road conditions of the lane of the vehicle.

11. A system comprising:
data processing hardware; and
memory hardware in communication with the data processing hardware, the memory hardware storing instructions that when executed on the data processing hardware cause the data processing hardware to perform operations comprising:
while engaged in a first feature mode of a vehicle:
receiving a request to engage a second feature mode of the vehicle, the second feature mode different from the first feature mode;
identifying, based on conditions of the vehicle, that a trajectory of the vehicle is offset from a center of a lane of the vehicle;
determining that the conditions of the vehicle do not exceed a dynamic stabilization threshold; and
generating trajectory instructions instructing the vehicle to transition from the first feature mode of the vehicle to the second feature mode of the vehicle.

12. The system of claim 11, wherein the trajectory instructions maintain the trajectory of the vehicle that is offset from the center of the lane of the vehicle as the vehicle transitions from the first feature mode to the second feature mode.

13. The system of claim 11, wherein the first feature mode includes a first set of feature states and the second feature mode includes a second set of feature states.

14. The system of claim 13, wherein the first set of feature states and the second set of feature states include at least one common feature state.

15. The system of claim 14, wherein the trajectory instructions blend the at least one common feature state as the vehicle transitions from the first feature mode to the second feature mode.

16. The system of claim 14, wherein the operations further include applying a gradient rate limiter to the at least one common feature state as the vehicle transitions from the first feature mode to the second feature mode.

17. The system of claim 11, wherein the conditions of the vehicle comprise one or more of:
a heading angle of the vehicle with respect to the center of the lane of the vehicle; and
a lateral offset of the vehicle with respect to the center of the lane of the vehicle.

18. A computer-implemented method when executed on data processing hardware causes the data processing hardware to perform operations comprising:
receiving initial road conditions of a lane of a vehicle;
setting a dynamic stabilization threshold based on the initial road conditions of the lane of the vehicle;
identifying conditions of the vehicle;
performing a stabilization check of the vehicle to determine whether the conditions of the vehicle exceed the dynamic stabilization threshold; and
when the conditions of the vehicle do not exceed the dynamic stabilization threshold, permitting the vehicle to transition between a first feature mode and a second feature mode.

19. The method of claim 18, wherein the road conditions comprise one or more of:
a width of the lane of the vehicle;
a curvature of the lane of the vehicle;
road features; and
accessories of the vehicle.

20. The method of claim 18, wherein the operations further comprise receiving updated road conditions of the lane of the vehicle, the updated road conditions different from the initial road conditions; and
adjusting the dynamic stabilization threshold based on the updated road conditions of the lane of the vehicle.
